(19) United States
(12) Patent Application Publication
(10) Pub. No.: US 2009/0029181 A1
(43) Pub. Date: Jan. 29, 2009

(54) PHOTOCURABLE AND THERMOSETTING RESIN COMPOSITION, CURED PRODUCT THEREOF, AND PRINTED WIRING BOARD OBTAINED BY USING THE SAME

(76) Inventors: Yoko Shibasaki, Hiki-gun (JP); Kenji Kato, Hiki-gun (JP); Nobuhito Itoh, Hiki-gun (JP); Masao Arima, Hiki-gun (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/240,660

(22) Filed: Sep. 29, 2008

Related U.S. Application Data
(63) Continuation of application No. PCT/JP07/56471, filed on Mar. 27, 2007.

(30) Foreign Application Priority Data
Mar. 29, 2006 (JP) 2006-089700

(51) Int. Cl. B32B 15/08; C08L 33/02

(52) U.S. Cl. 428/457; 522/14

(57) ABSTRACT

A photocurable and thermosetting resin composition developable with a dilute alkaline solution containing: (A) an ethylenic unsaturated group-containing and carboxylic acid-containing resin, (B) a coumarin skeleton-containing sensitizer having a maximum absorption wavelength of 360 to 410 nm, as represented by the following Formula (I):

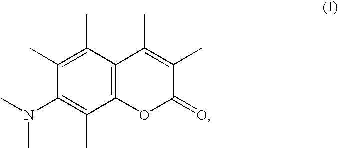

(C) a photopolymerization initiator, (D) a compound having two or more ethylenic unsaturated groups in the molecule, (E) a filler, and (F) a thermosetting component.

### CROSS REFERENCE TO RELATED APPLICATIONS

This is a Continuation Application of PCT Application No. PCT/JP2007/056471, filed Mar. 27, 2007, which was published under PCT Article 21(2) in Japanese.

This application is based upon and claims the benefit of priority from prior Japanese Patent Application No. 2006-089700, filed Mar. 29, 2006, the entire contents of which are incorporated herein by reference.

### BACKGROUND OF THE INVENTION

1. Field of the Invention

The present invention relates to a photocurable and thermosetting resin composition useful as an insulation resin layer for various printed wiring boards requiring a solder resist and also for various electronic parts, the cured products thereof, and the printed wiring board obtained by using the same. More specifically, the invention relates to a photocurable and thermosetting resin composition which can be cured by irradiation of a laser beam at a wavelength of 400 to 410 nm, the cured product thereof, and the printed wiring board obtained by using the same.

2. Description of the Related Art

Printed wiring boards for electronic devices have a solder resist film formed as the outermost layer. The solder resist film is a protective coating material covering the surface of a printed wiring board and preventing adhesion of undesired solder on the circuit surface during application of solder and mounting of components. It is a protective film that protects the copper foil circuit of a printed wiring board from humidity, dust and others as a permanent protective mask and also protects the circuit from electrical problems as an insulator, and is superior in chemical and heat resistance and also resistant to the high temperature during soldering or gold plating. The solder resist pattern is generally formed by a photolithographic method of irradiating a high-energy ray through a mask pattern. It is possible to select regions requiring no soldering by using the mask pattern.

A laser direct imaging method of using a laser beam as a beam source has been commercialized recently as an environmentally-friendly photolithographic method for resource and energy conservation. Direct imaging apparatuses draw a pattern-data image directly on a printed circuit board carrying a laser beam-sensitive photocuring resin composition film formed thereon, by direct high-speed irradiation of a laser beam. It is characterized in that it requires no mask pattern, allows shortening of the production process and drastic reduction in the cost, and is suitable for multi-kind/small-lot and short-delivery-time production.

In such a direct imaging apparatus, in which all the surfaces in the light-exposing regions are not exposed to light simultaneously as by the conventional mask pattern exposure, the light-exposing and non-exposing regions are chosen before exposure of the film, consecutively exposed by on/off of the laser shutter. Thus, it is necessary to irradiate the film at high speed in order to obtain an exposure time close to that achieved by the conventional mask pattern exposure. In addition, the beam sources used by the conventional mask pattern exposure are those emitting a light having a wide wavelength range of 300 to 500 nm such as a metal halide lamp, but a gas laser, a semiconductor laser, a solid state laser, or the like is generally used instead as the beam source in the direct imaging apparatus, although the beam source and the wavelength may vary according to the application of the photocuring resin composition used. The wavelength commonly used is 355 nm, 405 nm or 488 nm.

Although a direct imaging apparatus using a carbon dioxide gas laser has been commercialized as a direct imaging apparatus using light in the ultraviolet range at 355 nm, it still has a problem of high running cost. Alternatively, a direct imaging apparatus using light in the visible light region at 488 nm requires handling under red light and thus, has a problem of the working environment. Under the circumstances above, direct imaging apparatuses using a semiconductor laser at 405 mm are now attracting attention.

For this reason, photopolymerization initiators having a high photopolymerization potential even with a laser beam having an emission line at 405 nm and compositions prepared by using the photopolymerization initiator have been proposed (see e.g., Patent Documents 1 and 2). However, although these techniques have a sufficient photopolymerization potential even with a laser beam having an emission line at 405 nm, they still have problems, for example, that it is not possible to obtain sufficiently high in-depth curability and surface curability because of its very high photopolymerization rate, and that there is a drastic drop in sensitivity because of inactivation of the photopolymerization initiator on the circuit after heat treatment and also exfoliation of the film on the copper circuit.

Patent Document 1: Jpn. Pat. Appln. KOKAI Publication No. 2001-235858 (claims)

Patent Document 2: WO 02/096969 (claims)

### BRIEF SUMMARY OF THE INVENTION

An object of the present invention is to provide a photocurable and thermosetting resin composition having a high photopolymerization potential as excited by a laser beam at 400 to 410 nm, exhibiting high in-depth curability, and being superior in thermostability, and in particular, to provide a photocurable and thermosetting resin composition for use in direct imaging by a laser beam at 400 to 410 mm in the solder resist application, the cured product thereof, and a printed wiring board patterned by using the same.

After intensive studies to achieve the object above, the inventors have found a photocurable and thermosetting resin composition that can be developed with a dilute alkaline solution comprising (A) an ethylenic unsaturated group-containing and carboxylic acid-containing resin, (B) a coumarin skeleton-containing sensitizer having a maximum absorption wavelength of 360 to 410 nm, as represented by the following Formula (I):

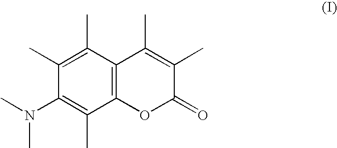

(C) a photopolymerization initiator, (D) a compound having two or more ethylenic unsaturated groups in the molecule, (E) a filler, and (F) a thermosetting component, which is a composition having a high photopolymerization potential as excited by a laser beam at a wavelength of 400 to 410 nm, exhibiting sufficient in-depth curability, and being superior in thermostability, and completed the present invention.

The form of the photocurable and thermosetting resin composition product according to the present invention may be liquid, or alternatively, a solid as a photosensitive dry film.

The present invention also provides a cured product of the photocurable and thermosetting resin composition according to the present invention, and a printed wiring board having an insulation layer patterned with the cured product.

The photocurable and thermosetting resin composition according to the present invention is superior in surface curability and in-depth curability, allows patterning with a laser beam at a wavelength of 400 to 410 nm, and can be used as a solder resist for laser direct imaging.

In addition, use of such a solder resist for laser direct imaging eliminates the need for a negative pattern and contributes to improving initial productivity and reducing the production cost.

Further, the sensitizer for use in the present invention, which has a maximum absorption wavelength in the ultraviolet range of 360 to 410 nm, allows production of a colorless composition, and thus, of a clear or blue solder resist composition.

Further, the photocurable and thermosetting resin composition according to the present invention, which is superior in in-depth curability and higher in sensitivity and resolution, can give a printed wiring board improved reliability.

### BRIEF DESCRIPTION OF THE SEVERAL VIEWS OF THE DRAWING

The single FIGURE is a schematic view illustrating the cross sectional shapes of the resin compositions obtained after exposure and development.

### DETAILED DESCRIPTION OF THE INVENTION

The photocurable and thermosetting resin composition according to the present invention is a composition that can be developed with a dilute alkaline solution comprising (A) an ethylenic unsaturated group-containing and carboxylic acid-containing resin, (B) a sensitizer having a maximum absorption wavelength of 360 to 410 nm, (C) a photopolymerization initiator, (D) a compound having two or more ethylenic unsaturated groups in the molecule, (E) a filler, and (F) a thermosetting component.

Hereinafter, each constituent component of the photocurable and thermosetting resin composition according to the present invention will be described in detail.

The ethylenic unsaturated group-containing and carboxylic acid-containing resin (A) contained in the photocurable and thermosetting resin composition according to the present invention is a known and commonly used resin compound having an ethylenic unsaturated double bond and a carboxyl group in the molecule.

Specific examples thereof include, but are not limited to, the following resins:

(1) Ethylenic unsaturated group-containing and carboxylic acid-containing resins obtained by adding an ethylenic unsaturated group as a pendant to a copolymer of an unsaturated carboxylic acid such as (meth)acrylic acid and one or more other compounds having an unsaturated double bond with a compound having an epoxy group and an unsaturated double bond such as glycidyl (meth)acrylate or 3,4-epoxycyclohexylmethyl (meth)acrylate or (meth)acrylic chloride;

(2) Ethylenic unsaturated group-containing and carboxylic acid-containing resins obtained by allowing an unsaturated carboxylic acid such as (meth)acrylic acid to react with a copolymer of a compound having an epoxy group and an unsaturated double bond such as glycidyl (meth)acrylate or 3,4-epoxycyclohexylmethyl (meth)acrylate and another compound having an unsaturated double bond and also allowing a polybasic acid anhydride to react with the generated secondary hydroxyl group;

(3) Ethylenic unsaturated group-containing and carboxylic acid-containing resins obtained by allowing a compound having a hydroxyl group and an unsaturated double bond such as 2-hydroxyethyl (meth)acrylate to react with a copolymer of an acid anhydride having an unsaturated double bond such as maleic anhydride and another compound having an unsaturated double bond;

(4) Ethylenic unsaturated group-containing and carboxylic acid-containing resins obtained by allowing a multifunctional epoxy compound to react with an unsaturated monocarboxylic acid and then allowing a saturated or unsaturated polybasic acid anhydride to react with the generated hydroxyl group;

(5) Ethylenic unsaturated group-containing and carboxylic acid-containing resins having hydroxyl groups obtained by allowing a saturated or unsaturated polybasic acid anhydride to react with a hydroxyl group-containing polymer such as a polyvinyl alcohol derivative and then allowing a compound having an epoxy group and an unsaturated double bond in one molecule to react with the generated carboxylic acid;

(6) Ethylenic unsaturated group-containing and carboxylic acid-containing resins obtained by allowing a saturated or unsaturated polybasic acid anhydride to react with a reaction product of a multifunctional epoxy compound, an unsaturated monocarboxylic acid, and a compound having at least one alcoholic hydroxyl group and a reactive group reactive with an epoxy group other than the alcoholic hydroxyl group in one molecule;

(7) Ethylenic unsaturated group-containing and carboxylic acid-containing resins obtained by allowing an unsaturated monocarboxylic acid to react with a multifunctional oxetane compound having at least two oxetane rings in one molecule and then allowing a saturated or unsaturated polybasic acid anhydride to react with the primary hydroxyl groups in the modified oxetane resin obtained; and

(8) Ethylenic unsaturated group-containing and carboxylic acid-containing resins obtained by allowing a compound having one oxirane ring and one or more ethylenic unsaturated groups in the molecule to react with a carboxyl group-containing resin that is previously obtained by allowing an unsaturated monocarboxylic acid and then a polybasic acid anhydride to react with a multifunctional epoxy resin.

Preferable among these exemplified compounds are the ethylenic unsaturated group-containing and carboxylic acid-containing resins of (1), (4), (6), and (8), and particularly preferable are the ethylenic unsaturated group-containing and carboxylic acid-containing resins of (8), from the viewpoints of photocurability and cured coated film properties.

In the present specification, the (meth)acrylate is a generic term indicating acrylate, methacrylate, or a mixture thereof, and the other similar terms are also defined similarly.

Such an ethylenic unsaturated group-containing and carboxylic acid-containing resin (A) has multiple free carboxyl groups on the side chains of the backbone polymer and thus, can be developed with a dilute aqueous alkaline solution.

The acid value of the ethylenic unsaturated group-containing and carboxylic acid-containing resin (A) is preferably in the range of 40 to 200 mgKOH/g, more preferably in the range of 45 to 120 mgKOH/g. When the acid value of the ethylenic unsaturated group-containing and carboxylic acid-containing resin is less than 40 mgKOH/g, alkali development becomes more difficult, while, when it is more than 200 mgKOH/g, the light-exposed region is undesirably dissolved more by the developing solution, leading to undesirable thinning of lines and occasionally also to solubilization and removal indiscriminately of the layer in the light-exposed and unexposed regions by the developing solution and prohibition of normal drawing of the resist pattern.

The weight-average molecular weight of the ethylenic unsaturated group-containing and carboxylic acid-containing resin (A) may vary according to its resin skeleton, but is generally in the range of 2,000 to 150,000, preferably 5,000 to 100,000. A weight-average molecular weight of less than 2,000 may lead to an insufficient tack-free property and deterioration in moisture resistance of the coated film after exposure, consequently to corrosion of the film during development and significant decline in its resolution. Alternatively, a weight-average molecular weight of more than 150,000 may lead to drastic deterioration in development property and also to insufficient storage stability.

The blending rate of the ethylenic unsaturated group-containing and carboxylic acid-containing resin (A) is preferably 20 to 60 mass %, more preferably 30 to 50 mass %, in the entire composition. A blending rate below the range above is unfavorable, because it may lead to deterioration in the strength of the coated film. Alternatively, a blending rate beyond the above range is also unfavorable, because it may lead to increase in viscosity or deterioration in the coating property or the like.

Examples of the sensitizers (B) for use in the present invention, having a maximum absorption wavelength of 360 to 410 nm and containing a coumarin skeleton represented by the following Formula (I):

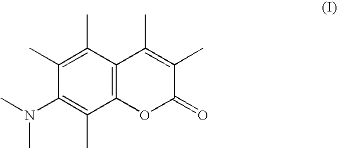

include the compounds represented by the following Formulae (I-1) to (I-4):

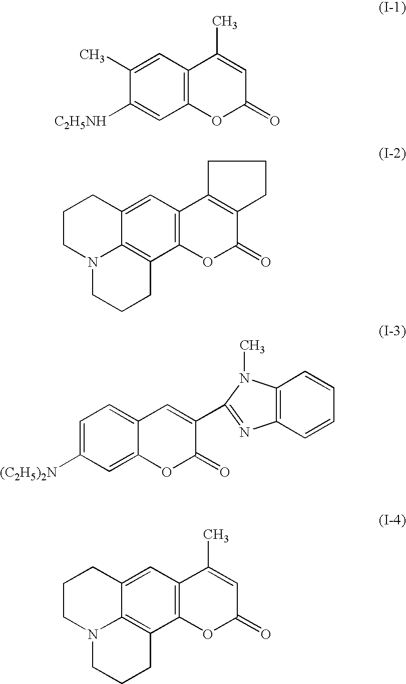

and 7-(diethylamino)-4-methyl-2H-1-benzopyran-2-one represented by the following Formula (II):

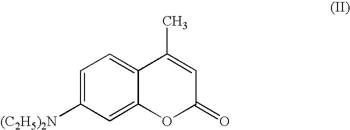

Such nitrogen atom-containing coumarin-based sensitizers (B) are found to have superior sensitization efficiency with a laser beam having a wavelength of 400 to 410 nm, in interaction with the ethylenic unsaturated group-containing and carboxylic acid-containing resin (A). In addition, unlike common coumarin-based sensitizers, which are green to yellow in color, such sensitizers have a maximum absorption wavelength of 360 to 410 nm and thus, are less colored, because the maximum absorption wavelength is in the ultraviolet region, and can give transparent and colorless solder resist compositions and blue solder resists.

Among these sensitizers, 7-(diethylamino)-4-methyl-2H-1-benzopyran-2-one, the compound represented by the Formula (II), is preferable, because it has superior sensitization efficiency to a laser beam at a wavelength of 400 to 410 nm.

The blending rate of the sensitizer (B) is 0.1 to 5 parts by mass, preferably 0.5 to 2 parts by mass, with respect to 100 parts by mass of the ethylenic unsaturated group-containing and carboxylic acid-containing resin (A). A blending rate of below the range above unfavorably results in insufficient sensitization efficiency. Alternatively, a blending rate beyond the above range unfavorably leads to deterioration in in-depth curability because of light absorption by the sensitizer.

Examples of the photopolymerization initiators (C) for use in the present invention include known common radical photopolymerization initiators such as those based on benzophenone, acetophenone, aminoacetophenone, benzoin ether, benzylketal, acylphosphine oxide, oxime ether, oxime ester, and titanocene, but it is preferable to use one or more photopolymerization initiators selected from the group consisting of oxime ester-based photopolymerization initiators represented by the following General Formula (III), aminoacetophenone-based photopolymerization initiators represented by the following General Formula (IV), acylphosphine oxide-based photopolymerization initiators represented by the following General Formula (V), and titanocene-based photopolymerization initiators represented by the following General Formula (VI).

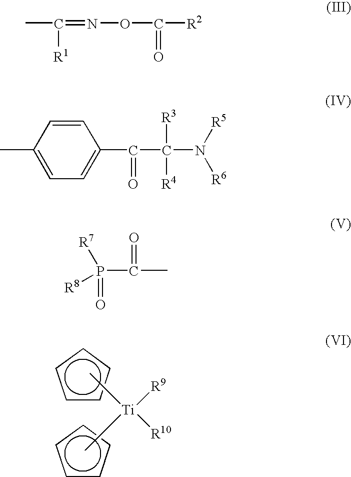

In the Formulae, R¹ represents a hydrogen atom, an alkyl group having 1 to 7 carbon atoms, or a phenyl group; R² represents an alkyl group having 1 to 7 carbon atoms or a phenyl group; R³ and R⁴ each represent an alkyl having 1 to 12 carbon atoms or arylalkyl group; R⁵ and R⁶ each represent a hydrogen atom or an alkyl group having 1 to 6 carbon atoms, or may be bound to each other to form a cyclic alkyl group; R⁷ and R⁸ each represent a linear or branched alkyl group having 1 to 6 carbon atoms, a cyclohexyl group, a cyclopentyl group, an aryl group, a halogen atom, an aryl group substituted with an alkyl or alkoxy group, or a carbonyl group having 1 to 21) carbon atoms, with the proviso that R⁷ and R⁸ are not carbonyl groups having 1 to 20 carbon atoms simultaneously; and R⁹ and R¹⁰ each represent a halogen atom, an aryl group, a halogenated aryl group, or a halogenated aryl group having a heterocyclic ring.

Examples of the oxime ester-based photopolymerization initiators represented by the General Formula (III) include 1,2-octandione-1-[4-(phenylthio)-2-(O-benzoyloxime)], ethanone-1-[9-ethyl-6-(2-methylbenzoyl)-9H-carbazol-3-yl]-1-(O-acetyloxime), 2-(acetyloxyiminomethyl)thioxanthen-9-one represented by the following Formula (VII), and the like.

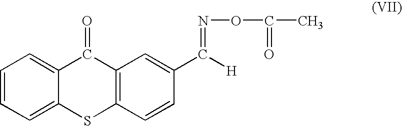

Among these compounds, the compound represented by the Formula (VII), 2-(acetyloxyiminomethyl)thioxanthen-9-one, is particularly preferable. A commercial product of the compound is CGI-325 manufactured by Ciba Specialty Chemicals.

Examples of the aminoacetophenone-based photopolymerization initiators represented by the General Formula (IV) include 2-methyl-1-[4-(methylthio)phenyl]-2-morpholinoaminopropanone-1,2-benzyl-2-dimethylamino-1-(4-morpholinophenyl)-butan-1-one, 2-(dimethylamino)-2-[(4-methylphenyl)methyl]-1-[4-(4-morpholinyl)phenyl]-1-butanone, N,N-dimethylaminoacetophenone and the like. Commercial products thereof include Irgacure-907, Irgacure-369, and Irgacure-379 manufactured by Ciba Specialty Chemicals.

Examples of the acylphosphine oxide-based photopolymerization initiators represented by the General Formula (V) include 2,4,6-trimethylbenzoyldiphenylphosphineoxide, bis(2,4,6-trimethylbenzoyl)-phenylphosphineoxide, bis(2,6-dimethoxybenzoyl)-2,4,4-trimethyl-pentylphosphineoxide, and the like. Commercial products thereof include Lucirin TPO manufactured by BASF, Irgacure-819 manufactured by Ciba Specialty Chemicals, and the like.

Examples of the titanocene-based photopolymerization initiators represented by the General Formula (VI) include bis(η⁵-cyclopentadienyl)-bis(2,6-difluoro-3-(1H-pyrrol-1-yl)phenyl)titanium. Commercial products include Irgacure-784 manufactured by Ciba Specialty Chemicals, and the like.

The blending rate of the photopolymerization initiator (C) is preferably 0.01 to 30 parts by mass, more preferably 0.5 to 15 parts by mass, with respect to 100 parts by mass of the ethylenic unsaturated group-containing and carboxylic acid-containing resin (A). A photopolymerization initiator (C) blending rate of smaller than 0.01 part by mass with respect to 100 parts by mass of the ethylenic unsaturated group-containing and carboxylic acid-containing resin (A) unfavorably leads to insufficient photocurability on a copper substrate, consequently to separation of the coated film and deterioration in coated film properties such as chemical resistance. On the other hand, a photopolymerization initiator (C) blending rate of more than 30 parts by mass with respect to 100 parts by mass of the ethylenic unsaturated group-containing and carboxylic acid-containing resin (A) unfavorably leads to deterioration in in-depth curability because of light absorption by the photopolymerization initiator (C).

In the case of the oxime ester-based photopolymerization initiator represented by the Formula (VII) above, the blending rate thereof is more preferably 0.01 to 20 parts by mass, more preferably 0.01 to 5 parts by mass, with respect to 100 parts by mass of the ethylenic unsaturated group-containing and carboxylic acid-containing resin (A). In using such an oxime ester-based photopolymerization initiator, it is preferable to use, for example, an aminoacetophenone-based photopolymerization initiator in combination, because the oxime ester-based initiator may be inactivated in its function as a photopolymerization initiator in reaction with copper atoms at the interface with the copper foil.

The photocurable and thermosetting resin composition according to the present invention may contain additionally as needed a known photopolymerization initiator such as benzoin or a benzoin alkylether such as benzoin, benzoin methylether, benzoin ethylether, or benzoin isopropylether; an acetophenone derivative such as acetophenone, 2,2-dimethoxy-2-phenylacetophenone, 2,2-diethoxy-2-phenylacetophenone, or 1,1-dichloroacetophenone; an anthraquinone derivative such as 2-methylanthraquinone, 2-ethylanthraquinone, 2-t-butylanthraquinone, or 1-chloroanthraquinone; a thioxanthone derivative such as 2,4-dimethylthioxanthone, 2,4-diethylthioxanthone, 2-chlorothioxanthone, or 2,4-diisopropylthioxanthone; a ketal derivative such as acetophenone dimethylketal, or benzyldimethylketal; a benzophenone or xanthone derivative such as benzophenone, 4-benzoyldiphenylsulfide, 4-benzoyl-4′-methyldiphenylsulfide, 4-benzoyl-4′-ethyldiphenylsulfide, or 4-benzoyl-4′-propyldiphenylsulfide; or the like. In particular, combined use of a thioxanthone compound (H) such as 2,4-dimethylthioxanthone, 2,4-diethylthioxanthone, 2-chlorothioxanthone, or 2,4-diisopropylthioxanthone is preferable from the viewpoint of in-depth curability.

In addition, the photocurable and thermosetting resin composition according to the present invention may contain a tertiary amine compound or a benzophenone compound as a photoinitiator aid. Examples of the tertiary amines include ethanolamines; dialkylaminobenzophenones (G) such as 4,4′-dimethylaminobenzophenone (Nissocure-MABP, manufactured by Nippon Soda), and 4,4′-diethylaminobenzophenone (EAB, manufactured by Hodogaya Chemical); ethyl 4-dimethylaminobenzoate (Kayacure EPA, manufactured by Nippon Kayaku), ethyl 2-dimethylaminobenzoate (Quantacure DMB, manufactured by International Bio-Synthetics), 4-(n-butoxy)ethyl dimethylaminobenzoate (Quantacure BEA, manufactured by International Bio-Synthetics), isoamylethyl ester p-dimethylaminobenzoate (Kayacure DMBI, manufactured by Nippon Kayaku), 2-ethylhexyl 4-dimethylaminobenzoate (Esolol 507, manufactured by Van Dyk), 4,4′-diethylaminobenzophenone (EAB, manufactured by Hodogaya Chemical), and the like. The known tertiary amine compounds may be used alone or in combination of two or more.

Particularly preferable tertiary amine compounds include dialkylaminobenzophenones (G) such as 4,4′-dimethylaminobenzophenone and 4,4′-diethylaminobenzophenone. These compounds may be used alone or in combination of two or more.

The total amount of the photopolymerization initiator and the photoinitiator aid is favorably in the range of 35 parts or less by mass, with respect to 100 parts by mass of the ethylenic unsaturated group-containing and carboxylic acid-containing resin (A). A total amount beyond the above range may unfavorably lead to deterioration in in-depth curability because of light absorption by the compound.

When a composition containing a coloring pigment described below is used, the dry coated film thereof preferably has an absorbance of 0.3 to 1.5 per 25 μm of the film thickness, more preferably 0.4 to 1.2, at a wavelength of 405 nm. An absorbance beyond the above range undesirably leads to deterioration in in-depth curability because of light absorption by the pigment.

The compound (D) having two or more ethylenic unsaturated groups in the molecule used in the photocurable and thermosetting resin composition according to the present invention is photo-cured by high-energy ray irradiation, insolubilizing the ethylenic unsaturated group-containing and carboxylic acid-containing resin (A) or accelerating the insolubilization of it in an aqueous alkaline solution. Examples of the compounds include glycol diacrylates such as ethylene glycol, methoxytetraethylene glycol, polyethylene glycol, and propylene glycol; polyvalent acrylates of a polyvalent alcohol such as hexanediol, trimethylolpropane, pentaerythritol, dipentaerythritol, or tris-hydroxyethyl isocyanurate, and the ethyleneoxide or propyleneoxide adducts thereof; polyvalent acrylates such as phenoxy acrylate, bisphenol A diacrylate, and the ethyleneoxide or propyleneoxide adducts thereof; polyvalent acrylate glycidyl ethers such as glycerol diglycidyl ether, glycerol triglycidyl ether, trimethylolpropane triglycidyl ether, and triglycidyl isocyanurate; melamine acrylate, and/or the methacrylates corresponding to the acrylates above; and the like.

Other examples include epoxy acrylate resins obtained in reaction of a multifunctional epoxy resin such as cresol novolak-type epoxy resin with acrylic acid, epoxy urethane acrylate compounds obtained in reaction of the hydroxyl groups of the epoxy acrylate resin with hydroxy acrylate such as pentaerythritol triacrylate and a diisocyanate half urethane compound such as isophorone diisocyanate, and the like. Such an epoxy acrylate-based resin improves the photocurability of the resulting film without lowering its tack-free drying efficiency.

The blending rate of the compound (D) having two or more ethylenic unsaturated groups in the molecule is preferably 5 to 100 parts by mass, more preferably 1 to 70 parts by mass, with respect to 100 parts by mass of the ethylenic unsaturated group-containing and carboxylic acid-containing resin (A). A blending rate of less than 5 parts by mass unfavorably leads to deterioration in photocurability, often making it difficult to form a pattern by alkali development after high-energy ray irradiation. Alternatively, a blending rate of more than 100 parts by mass unfavorably leads to deterioration in solubility in aqueous alkaline solution and increase of the brittleness of the coated film.

Any known inorganic or organic filler may be used as the filler (E) for use in the present invention, but use of barium sulfate or spherical silica is particularly preferable. Other preferable examples thereof include dispersion of nano silica in the compound having two or more ethylenic unsaturated groups (D) described above or the multifunctional epoxy resin (F-1) described below, such as NANOCRYL (trade name) XP0396, XP0596, XP0733, XP0746, XP0765, XP0768, XP0953, XP0954, and XP1045 (product grade name) manufactured by Hanse Chemie and NANOPOX (trade name) XP0516, XP0525, and XP0314 (product grade name) manufactured by Hanse Chemie.

These compounds may be blended alone or in combination of two or more. These fillers are used for the purpose of controlling curing shrinkage of the coated film and improving the basic properties such as adhesiveness and hardness of the film, and also of reducing disturbance of light reflection or refraction during transmission of the high-energy ray through the photocuring resin composition.

The blending rate of the filler (E) is preferably 0.1 to 300 parts by mass, more preferably 0.1 to 150 parts by mass, with respect to 100 parts by mass of the ethylenic unsaturated group-containing and carboxylic acid-containing resin (A). A filler (E) blending rate of less than 0.1 part by mass unfavorably leads to deterioration in cured coated film properties such as solder heat resistance and gold-plating resistance. On the other hand, a blending rate of more than 300 parts by mass unfavorably leads to increase in viscosity of the composition and thus to deterioration in printability and increase in brittleness of the cured product.

Any known thermosetting resin such as amino resin (e.g., melamine resin or benzoguanamine resin), block isocyanate compound, cyclocarbonate compound, multifunctional epoxy compound, multifunctional oxetane compound, or episulfide resin may be used as the thermosetting component (F) for use in the invention. Particularly favorable among these compounds are multifunctional epoxy compounds (F-1), multifunctional oxetane compounds (F-2), and thermosetting components having two or more cyclic ether groups and/or a cyclic thioether group in the molecule such as episulfide resins (hereinafter, referred to as cyclic (thio)ether compounds).

Examples of the polyfunctional epoxy compounds (F-1) include, but are not limited to, bisphenol A epoxy resins such as Epikote 828, Epikote 834, Epikote 1001 and Epikote 1004 manufactured by Japan Epoxy Resin, Epichlone 840, Epichlone 850, Epichlone 1050 and Epichlone 2055 manufactured by Dainippon Ink and Chemicals, Inc., Epotohto YD-011, YD-013, YD-127 and YD-128 manufactured by Tohto Kasei, D.E.R.317, D.E.R.331, D.E.R.661 and D.E.R.664 manufactured by Dow Chemical Company, Araldite 6071, Araldite 6084, Araldite GY250 and Araldite GY260 manufactured by Ciba Specialty Chemicals, Sumi-epoxy ESA-011, ESA-014, ELA-115 and ELA-128 manufactured by Sumitomo Chemical, and A.E.R.330, A.E.R.331, A.E.R.661 and A.E.R.664 manufactured by Asahi Kasei Corp. (all trade names); brominated epoxy resins such as Epicoat YL903 manufactured by Japan Epoxy Resin, Epichlone 152 and Epichlone 165 manufactured by Dainippon Ink and Chemicals, Inc., Epotohto YDB-400 and YDB-500 manufactured by Tohto Kasei, D.E.R.542 manufactured by Dow Chemical Company, Araldite 8011 manufactured by Ciba Specialty Chemicals, Sumi-epoxy ESB-400 and ESB-700 manufactured by Sumitomo Chemical, and A.E.R.711 and A.E.R.714 manufactured by Asahi Kasei Corp. (all trade names); novolak epoxy resins such as Epikote 152 and Epikote 154 manufactured by Japan Epoxy Resin, D.E.N.431 and D.E.N.438 manufactured by Dow Chemical Company, Epiclon N-730, Epiclon N-770 and Epiclon N-865 manufactured by Dainippon Ink and Chemicals, Inc., Epotohto YDCN-701 and YDCN-704 manufactured by Tohto Kasei, Araldite ECN1235, Araldite ECN1273, Araldite ECN1299 and Araldite XPY307 manufactured by Ciba Specialty Chemicals, EPPN-201, EOCN-1025, EOCN-1020, EOCN-104S and RE-306 manufactured by Nippon Kayaku, Sumi-epoxy ESCN-195× and ESCN-220 manufactured by Sumitomo Chemical, and A.E.R. ECN-235 and ECN-299 manufactured by Asahi Kasei Corp. (all trade names); bisphenol F epoxy resins such as Epichlone 830 manufactured by Dainippon Ink and Chemicals, Inc., Epikote 807 manufactured by Japan Epoxy Resin, Epotohto YDF-170, YDF-175 and YDF-2004 manufactured by Tohto Kasei, and Araldite XPY306 manufactured by Ciba Specialty Chemicals (all trade names); hydrogenated bisphenol A epoxy resin such as Epotohto ST-2004, ST-2007 and ST-3000 (trade name) manufactured by Tohto Kasei; glycidylamine epoxy resins such as Epikote 604 manufactured by Japan Epoxy Resin, Epotohto YH-434 manufactured by Tohto Kasei, Araldite MY720 manufactured by Ciba Specialty Chemicals, and Sumi-epoxy ELM-120 manufactured by Sumitomo Chemical (all trade names); hydantoin epoxy resins such as Araldite CY-350 (trade name) manufactured by Ciba Specialty Chemicals; alicyclic epoxy resins such as Celoxide 2021 manufactured by Daicel Chemical Industries, Ltd., and Araldite CY175 and CY179 manufactured by Ciba Specialty Chemicals (all trade names); trihydroxyphenylmethane epoxy resins such as YL-933 manufactured by Japan Epoxy Resin, and T.E.N., EPPN-501 and EPPN-502 manufactured by Dow Chemical Company (all trade names); bixylenol or biphenol epoxy resins or the mixture thereof such as YL-6056, YX-4000 and YL-6121 (all trade names) manufactured by Japan Epoxy Resin; bisphenol S epoxy resins such as EPBS-200 manufactured by Nippon Kayaku, EPX-30 manufactured by Asahi Denka, and EXA-1514 manufactured by Dainippon Ink and Chemicals, Inc. (trade name); bisphenol A novolak epoxy resins such as Epikote 157S (trade name) manufactured by Japan Epoxy Resin; tetraphenylolethane epoxy resins such as Epicoat YL-931 manufactured by Japan Epoxy Resin, and Araldite 163 manufactured by Ciba Specialty Chemicals (all trade names); heterocyclic epoxy resins such as Araldite PT810 manufactured by Ciba Specialty Chemicals, and TEPIC manufactured by Nissan Chemical Industries (all trade names); diglycidyl phthalate resin such as Blemmer DGT manufactured by NOF Corporation; tetraglycidyl xylenoyl ethane resins such as ZX-1063 manufactured by Tohto Kasei; naphthalene group-containing epoxy resins such as ESN-190 and ESN-360 manufactured by Nippon Steel Chemical, and HP-4032, EXA-4750 and EXA-4700 manufactured by Dainippon Ink and Chemicals, Inc.; dicyclopentadiene skeleton-containing epoxy resins such as HP-7200 and HP-7200H manufactured by Dainippon Ink and Chemicals, Inc.; glycidyl methacrylate copolymer epoxy resins such as CP-50S and CP-50M manufactured by NOF Corporation; cyclohexylmaleimide/glycidyl methacrylate copolymer epoxy resins; epoxy-modified polybutadiene rubber derivatives (e.g., PB-3600 manufactured by Daicel Chemical Industries), and CTBN-modified epoxy resins (e.g., YR-102 and YR-450 manufactured by Tohto Kasei). These epoxy resins may be used alone or in combination of two or more. Particularly preferable among them are novolak epoxy resins, heterocyclic epoxy resins, and bisphenol A epoxy resins, or a mixture thereof.

Examples of the multifunctional oxetane compounds (F-2) include bis[(3-methyl-3-oxetanylmethoxy)methyl]ether, bis[(3-ethyl-3-oxetanylmethoxy)methyl]ether, 1,4-bis[(3-methyl-3-oxetanylmethoxy)methyl]benzene, 1,4-bis[(3-ethyl-3-oxetanylmethoxy)methyl]benzene, (3-methyl-3-oxetanyl)methyl acrylate, (3-ethyl-3-oxetanyl)methyl acrylate, (3-methyl-3-oxetanyl)methyl methacrylate, (3-ethyl-3-oxetanyl)methyl methacrylate, multifunctional oxetanes such as oligomers or copolymers thereof, oxetane/novolak resins, etherified derivatives of a hydroxyl group-containing resin such as poly(p-hydroxystyrene), cardo-type bisphenols, calixarenes, calix resorcinarenes, or silsesquioxane. Also included are copolymers of an unsaturated monomer having an oxetane ring and an alkyl (meth)acrylate.

Examples of the compounds having two or more cyclic thioether groups in the molecule include bisphenol A episulfide resin YL7000 manufactured by Japan Epoxy Resin. It is also possible to use an episulfide resin prepared by a similar synthetic method, while replacing the oxygen atoms in the epoxy groups of novolak type epoxy resin with sulfur atoms.

The blending rate of the cyclic (thio)ether compound is preferably in the range of 0.6 to 2.0 equivalences, more preferably 0.8 to 1.5 equivalences, with respect to one equivalence of the carboxyl group of the ethylenic unsaturated group-containing and carboxylic acid-containing resin (A). A blending rate of the cyclic (thio)ether compound below the range unfavorably leads to residual of the carboxyl groups, which in turn leads to deterioration, for example, in heat resistance, alkali resistance, and electrical insulation property. On the other hand, a blending rate beyond the above range unfavorably leads to residual of low-molecular weight cyclic (thio)ether groups, which in turn leads to deterioration in the strength of the coated film.

When the cyclic (thio)ether compound is used, the photocurable and thermosetting resin composition according to the present invention preferably contains a thermosetting catalyst. Examples of the thermosetting catalysts include imidazole derivatives such as imidazole, 2-methylimidazole, 2-ethylimidazole, 2-ethyl-4-methylimidazole, 2-phenylimidazole, 4-phenylimidazole, 1-cyanoethyl-2-phenylimidazole, and 1-(2-cyanoethyl)-2-ethyl-4-methylimidazole; amine compounds such as dicyandiamide, benzyldimethylamine, 4-(dimethylamino)-N,N-dimethylbenzylamine, 4-methoxy-N,N-dimethylbenzylamine, and 4-methyl-N,N-dimethylbenzylamine; hydrazine compounds such as adipic hydrazide and sebacic hydrazide; and phosphorus compounds such as triphenylphosphine. Commercially available products thereof include, for example, 2MZ-A, 2MZ-OK, 2PHZ, 2P4BHZ, and 2P4 MHZ manufactured by Shikoku Corp. (all trade names of imidazole compounds), U-CAT3503N and U-CAT3502T manufactured by SAN-APRO (both trade names of dimethylamine block isocyanate compounds), and DBU, DBN, U-CATSA102, and U-CAT5002 (all bicyclic amidine compounds and the salts thereof). In addition to the examples above, any compounds, alone or in combination of two or more, may be used, as long as they accelerate the hardening reaction of the epoxy resin or the oxetane compound in the presence of a thermosetting catalyst or the reaction between the epoxy group and/or the oxetanyl group and the carboxyl group. Alternatively, an S-triazine derivative such as guanamine, acetoguanamine, benzoguanamine, melamine, 2,4-diamino-6-methacryloyloxyethyl-S-triazine, 2-vinyl-4,6-diamino-S-triazine, 2-vinyl-4,6-diamino-S-triazine adduct isocyanurate, or 2,4-diamino-6-methacryloyloxyethyl-S-triazine-adduct isocyanurate, which functions as an adhesiveness enhancer, may be used, preferably in combination with the thermosetting catalyst.

The blending rate of the thermosetting catalyst is normally the standard amount, and specifically, 0.1 to 20 parts by mass, preferably 0.5 to 15.0 parts by mass, with respect to 100 parts by mass of the ethylenic unsaturated group-containing and carboxylic acid-containing resin (A) or of the thermosetting component.

The photocurable and thermosetting resin composition according to the present invention may contain an additional organic solvent for synthesis of the ethylenic unsaturated group-containing and carboxylic acid-containing resin (A), or for adjustment of the composition or the viscosity of the coating solution to be coated on a substrate or a carrier film.

Examples of the organic solvents include ketones, aromatic hydrocarbons, glycol ethers, glycol ether acetates, esters, alcohols, aliphatic hydrocarbons, petroleum solvents, and the like. More specific examples thereof include ketones such as methylethylketone and cyclohexanone; aromatic hydrocarbons such as toluene, xylene and tetramethylbenzene; cellosolve, methyl cellosolve, butyl cellosolve; glycol ethers such as carbitol, methyl carbitol, butyl carbitol, propylene glycol monomethylether, dipropylene glycol monomethylether, dipropylene glycol diethylether, and triethylene glycol monoethylether; glycol ether acetates such as dipropylene glycol methylether acetate, propylene glycol methylether acetate, propylene glycol ethylether acetate, and propylene glycol butylether acetate; esters including acetate esters such as ethyl acetate, butyl acetate and the glycol ethers; alcohols such as ethanol, propanol, ethylene glycol, and propylene glycol; aliphatic hydrocarbons such as octane and decane; and petroleum solvents such as petroleum ether, petroleum naphtha, hydrogenated petroleum naphtha, and solvent naphtha.

The organic solvents above may be used alone or as a mixture of two or more solvents.

The photocurable and thermosetting resin composition according to the present invention may contain as needed other known additives, including known colorants such as phthalocyanine-blue, phthalocyanine-green, iodine green, disazo yellow, crystal violet, titanium oxide, carbon black, and naphthalene black; hydroquinone, hydroquinone monomethylether, t-butylcatechol, common thermal polymerization inhibitors such as pyrogallol and phenothiazine; known thickeners such as fine powder silica, organic bentonite, and montmorillonite; antifoaming agents and/or leveling agents such as those based on silicone, fluorine, and polymer; and imidazole-, thiazole-, and triazole-based and other silane-coupling agents.

It is possible to form a tack-free coated film of the photocurable and thermosetting resin composition according to the present invention, for example, by preparing a coating solution with a viscosity suitable for production with the organic solvent described above, applying the solution on a base material by dip coating, flow coating, roll coating, bar coater, screen printing, curtain coating, or the like, and drying the composition while vaporizing the organic solvent at a temperature of approximately 60 to 100° C. (predrying). It is also possible to form a resin insulation layer by applying the composition on a carrier film, drying the composition, winding the resulting film, and transferring the film onto a base material. Then, a resist pattern is formed by exposing the film through a patterned photomask selectively to a high-energy ray in a contact mode (or in a non-contact mode) and developing the light-unexposed region with a dilute aqueous alkaline solution (e.g., 0.3 to 3% aqueous sodium carbonate solution). It is possible to form a hardened coated film superior in various properties such as heat resistance, chemical resistance, moisture resistance, adhesiveness, and electrical properties, for example by hardening the film under heat at a temperature of approximately 140 to 180° C., i.e., in reaction of the carboxyl groups in the ethylenic unsaturated group-containing and carboxylic acid-containing resin (A) with the thermosetting component (F).

Examples of the base materials include copper-clad laminates of all grades (FR-4, etc.), for example high-frequency-circuit copper-clad laminates employing paper phenol, paper epoxy, glass cloth epoxy, glass polyimide, glass cloth/nonwoven fabric epoxy, glass cloth/paper epoxy, synthetic fiber epoxy, fluorine-polyethylene-PPO-cyanate ester, or the like, as well as polyimide film, PET film, glass substrate, ceramic substrate, wafer plate, and the like.

After application, the photocurable and thermosetting resin composition according to the present invention is vaporized and dried, for example, by using a hot air-circulation drying oven, IR oven, hot plate, or convection oven (by a method of using a heat source for heating air by steam and bringing the hot air in the dryer into contact with the film in the counter-current flow manner or spraying the heated air onto the film through a nozzle).

The coated film obtained after application and vaporization drying of the photocuring resin composition according to the present invention is then exposed to light (high-energy ray). The coated film hardens in the light-exposed region (region irradiated with the high-energy ray).

A direct imaging apparatus (e.g., direct laser-imaging apparatus which draws an image with a laser directly according to CAD data from a computer) may be used as the exposure machine used for the high-energy ray irradiation. The high-energy ray may be either a gas- or solid-state laser, as long as the laser beam has a maximum wavelength in the range of 350 to 420 nm, preferably 400 to 410 nm. The irradiation intensity may vary according to the thickness and the like of the film, but is generally in the range of 8 to 200 mJ/cm², preferably 10 to 100 mJ/cm², and more preferably 10 to 80 mJ/cm². Examples of the direct imaging apparatuses include products manufactured by Orbotech Japan, Pentax Corp., Hitachi Biamechanics, Ball Semiconductor and others, and any one of them may be used.

The development method may be an immersion, showering, spraying, brushing or other method, and an aqueous alkaline solution of potassium hydroxide, sodium hydroxide, sodium carbonate, potassium carbonate, sodium phosphate, sodium silicate, ammonia, or an amine may be used as the developing solution.

### EXAMPLES

Hereinafter, the present invention will be described in detail with reference to Examples and Comparative Examples, but it should be understood that the present invention is not limited to the following Examples.

### Preparative Example 1

In a 2-liter separable flask equipped with a stirrer, a thermometer, a condenser tube, a dropping funnel and a nitrogen-supplying tube, placed were 660 g of a cresol novolak type epoxy resin (EOCN-104S, manufactured by Nippon Kayaku Co., Ltd., softening point 92° C., epoxy equivalence: 220), 421.3 g of carbitol acetate, and 180.6 g of a solvent naphtha, and the mixture was stirred under heat of 90° C. until solubilization. The mixture was then cooled to 60° C.; 216 g of acrylic acid, 4.0 g of triphenylphosphine, and 1.3 g of methylhydroquinone were added thereto; and the mixture was allowed react at 100° C. for 12 hours, to obtain a reaction product having an acid value of 0.2 mgKOH/g. 241.7 g of tetrahydrophthalic anhydride was added thereto, and the mixture was heated to 90° C. and allowed to react at the same temperature for 6 hours, to obtain a solution of a carboxylic acid-containing resin (A) having an acid value of 50 mgKOH/g, a double bond equivalence (amount of resin by weight (g) per mole of unsaturated group) of 400, and a weight-average molecular weight of 7,000. Hereinafter, the solution of the carboxylic acid-containing resin will be referred to as varnish A-1.

### Preparative Example 2

In a 2-liter separable flask equipped with a stirrer, a thermometer, a condenser tube, a dropping funnel and a nitrogen-supplying tube, placed were 430 g of an o-cresol novolak type epoxy resin (epoxy equivalence: 215, average six phenol rings in one molecule) and 144 g (2 moles) of acrylic acid. The mixture was heated to 120° C. while stirred, and allowed to react at the same temperature for 10 hours. The reaction product was cooled to room temperature; 190 g (1.9 moles) of succinic anhydride was added thereto; and the mixture was heated to 80° C. and allowed to react for 4 hours. The reaction product was cooled again to room temperature. The solid product had an acid value of 139 mgKOH/g.

5.2 g (0.6 mole) of glycidyl methacrylate and 45.9 g of propylene glycol methyl ether acetate were added to the solution, and the mixture was heated to 110° C. while stirred and allowed to react at the same temperature for 6 hours. The reaction product was cooled to room temperature, to obtain a viscous solution. In this way, a solution of a carboxylic acid-containing resin (A) having the nonvolatile matter in an amount of 65 mass % and a solid matter acid value of 86 mgKOH/g was obtained. Hereinafter, the solution of the carboxylic acid-containing resin will be referred to as varnish A-2.

### Preparative Example 3

In a 2-liter separable flask equipped with a stirrer, a thermometer, a condenser tube, a dropping funnel and a nitrogen-supplying tube, placed were 215 parts of a cresol novolak type epoxy resin Epiclon N-680 (manufactured by Dainippon Ink and Chemicals, Inc., epoxy equivalence: 215) and 266.5 parts of carbitol acetate, and the mixture was dissolved under heat. 0.05 part of hydroquinone and 1.0 part of triphenylphosphine were added to the resin solution as the polymerization inhibitor and the reaction catalyst, respectively. The mixture was heated to 85 to 95° C.; 72 parts of acrylic acid was added gradually; and the mixture was allowed to react for 24 hours. 208 parts of half urethane, previously prepared in reaction of isophorone diisocyanate and pentaerythritol triacrylate at a molar ratio of 1:1, was added to the epoxy acrylate gradually dropwise, and the mixture was allowed to react at 60 to 70° C. for 4 hours. The epoxy urethane acrylate varnish thus obtained containing the compound (D) having two or more ethylenic unsaturated groups in the molecule will be referred to as varnish D-1 below.

Each of the resin solutions obtained in the Preparative Examples 1 to 3 and the various components shown in Table 1 were blended at the ratio (parts by mass) shown in Table 1, and the mixture was preliminarily agitated in a stirrer and kneaded in a three-roll mill, to prepare a photosensitive resin composition for a solder resist. The degree of dispersion of the photosensitive resin composition obtained, as determined by using a grindmeter manufactured by Erichsen, was 15 μm or less.

TABLE 1

| | Exam. | | | | | | | | | | | | Comp. | | |
|---|---|---|---|---|---|---|---|---|---|---|---|---|---|---|---|
| | 1 | 2 | 3 | 4 | 5 | 6 | 7 | 8 | 9 | 10 | 11 | 12 | 1 | 2 | 3 |
| Varnish A-1 | 30 | 30 | 30 | 30 | 30 | 30 | 30 | 30 | 30 | 30 | 30 | 30 | 30 | 30 | 30 |
| Varnish A-2 | 125 | 125 | 125 | 125 | 125 | 125 | 125 | 125 | 125 | 125 | 125 | 125 | 125 | 125 | 125 |
| Sensitizer(B-1)*¹ | 1 | — | 1 | 1 | 1 | 1 | 1 | 1 | 1 | 1 | 0.5 | 3 | — | — | — |
| Sensitizer(B-2)*² | — | 1 | — | — | — | — | — | — | — | — | — | — | — | — | — |
| Sensitizer(B-3)*³ | — | — | — | — | — | — | — | — | — | — | — | — | — | 0.5 | 0.5 |
| Photopolymerization(C-1)*⁴ | 2 | 2 | — | — | — | 2 | 2 | — | — | 2 | 1 | 3 | — | — | 2 |
| Photopolymerization(C-2)*⁵ | — | — | — | — | — | — | — | 2 | — | — | — | — | — | — | — |
| Photopolymerization(C-3)*⁶ | — | — | — | — | — | — | — | — | 2 | — | — | — | — | — | — |
| Photopolymerization(C-4)*⁷ | 6 | 6 | 12 | — | — | 6 | — | — | — | 6 | 6 | — | 12 | 12 | — |
| Photopolymerization(C-5)*⁸ | — | — | — | 4 | — | — | — | — | — | — | — | — | — | — | — |
| Photopolymerization(C-6)*⁹ | — | — | — | — | 5 | — | — | — | — | — | — | — | — | — | — |
| Phthalocyanine-blue | — | 0.9 | 0.9 | 0.9 | 0.9 | 0.9 | 0.9 | 0.9 | 0.9 | 0.9 | 0.9 | 0.9 | 0.9 | 0.9 | — |
| Varnish D-1 | 20 | 20 | 20 | 20 | 20 | 20 | 20 | 20 | 20 | 20 | 20 | 20 | 20 | 20 | 20 |
| Compound(D-2)*¹⁰ | 20 | 20 | 20 | 20 | 20 | 20 | 20 | 20 | 20 | 20 | 20 | 20 | 20 | 20 | 20 |
| Compound(D-3)*¹¹ | 10 | 10 | 10 | 10 | 10 | 10 | 10 | 10 | 10 | 10 | 10 | 10 | 10 | 10 | 10 |
| Filler(E-1)*¹² | 130 | 130 | 130 | 130 | 130 | 130 | 130 | 130 | 130 | 130 | 130 | 130 | 130 | 130 | 130 |
| Thermosetting component | 15 | 15 | 15 | 15 | 15 | 15 | 15 | 15 | 15 | 15 | 15 | 15 | 15 | 15 | 15 |
| (F-1-1)*¹³ | | | | | | | | | | | | | | | |
| Thermosetting component | 30 | 30 | 30 | 30 | 30 | 30 | 30 | 30 | 30 | 30 | 30 | 30 | 30 | 30 | 30 |
| (F-1-2)*¹⁴ | | | | | | | | | | | | | | | |
| Dialkylaminobenzophenone | 0.6 | 0.6 | 0.6 | 0.3 | 0.6 | — | — | — | — | — | — | 1 | 0.6 | 0.6 | 0.6 |
| (G-1)*¹⁵ | | | | | | | | | | | | | | | |
| thioxanthone compound | — | — | — | — | — | 1 | 1 | 1 | 1 | — | — | — | — | — | — |
| (H-1)*¹⁶ | | | | | | | | | | | | | | | |
| Fine melamine | 3 | 3 | 3 | 3 | 3 | 3 | 3 | 3 | 3 | 3 | 3 | 3 | 3 | 3 | 3 |
| Silicone antifoaming agent | 3 | 3 | 3 | 3 | 3 | 3 | 3 | 3 | 3 | 3 | 3 | 3 | 3 | 3 | 3 |
| DPM*¹⁷ | 5 | 5 | 5 | 5 | 5 | 5 | 5 | 5 | 5 | 5 | 5 | 5 | 5 | 5 | 5 |
| #150*¹⁸ | 5 | 5 | 5 | 5 | 5 | 5 | 5 | 5 | 5 | 5 | 5 | 5 | 5 | 5 | 5 |

Remarks
*¹Coumarin-based sensitizer represented by Formula (II) (maximum absorption wavelength 374 nm)
*²Coumarin-based sensitizer represented by Formula (I-4) (maximum absorption wavelength 390 nm)
*³3-(2-benzoimidazolyl)-7-dimethylamino-2H-1-benzopyran-2-on(maximum absorption wavelength 437 nm)
*⁴2-(acetyloxyiminomethyl)thioxanthen-9-one
*⁵OXE01 manufactured by Ciba Specialty Chemicals Co., Ltd.
*⁶OXE02 manufactured by Ciba Specialty Chemicals Co., Ltd.
*⁷2-benzyl-2-dimethylamino-1-(4-morpholinophenyl)-butan-1-one
*⁸Bis(2,4,6-trimethylbenzoyl)-phenylphosphineoxide
*⁹Titanocene-based photopolymerization initiator (Irgacure-784 manufactured by Ciba Specialty Chemicals Co., Ltd.)
*¹⁰Dipentaerythritol hexa-acrylate
*¹¹Trimethylolpropane tri-acrtlate
*¹²Barium sulfate (B-30 manufactured by Sakai Chemical Industry Co., Ltd.)
*¹³Phenol novolak epoxy resin (EPPN-201 manufactured by Nippon Kayaku Co., Ltd.)
*¹⁴Bixylenol epoxy resin (YX-4000 manufactured by Japan Epoxy Resin Co., Ltd.)
*¹⁵4,4′-diethylaminobenzophenone
*¹⁶2,4-diethylthioxanthone
*¹⁷Dipropylene glycol methylether acetate
*¹⁸Aromatic organic solvent manufactured by Idemitsu Oil Chemicals. Co., Ltd.

### Evaluation of Properties:

### <Surface Curability>

Each of the photocurable and thermosetting resin compositions obtained in Examples 1 to 12 and Comparative Examples 1 to 3 above was applied by screen printing on a substrate carrying a circuit pattern having a line/space ratio of 300/300 and having a copper thickness of 35 μm, which was previously polished with buff rolls, washed with water, and dried, and the film was dried in a hot air-circulating drying oven at 80° C. for 60 minutes. After drying, the substrate was exposed to light in a direct imaging apparatus irradiating a blue-purple laser at a maximum wavelength of 400 to 410 nm. The exposure pattern used was an entire-surface exposure pattern. The high-energy ray was so irradiated that the irradiation intensity on the photocurable and thermosetting resin composition was 40 mJ/cm². After exposure, the substrate was developed (30° C., 0.2 MPa, 1 mass % aqueous sodium carbonate solution) for 60 seconds, giving a developed pattern, which was then hardened thermally at 150° C. for 60 minutes, to obtain a hardened coated film.

The surface curability of the hardened coated film thus obtained was evaluated by measuring the glossiness at the 60° angle by using a glossimeter MicroTrigloss (manufactured by Big Gardener). As for the evaluation criteria, a glossiness of 50 or more after development was rated favorable, and a glossiness of less than 50, unfavorable. The evaluation results are summarized in Table 2.

### <Cross Sectional Shape>

Each of the photocurable and thermosetting resin compositions obtained in Examples 1 to 12 and Comparative Examples 1 to 3 was applied by screen printing on a substrate carrying a pattern of a line/space of 300/300 and having a copper thickness of 50 μm, which was previously polished with buff rolls, washed with water and dried, and the film was dried in a hot air-circulating drying oven at 80° C. for 30 minutes. After drying, the substrate was exposed to light in a direct imaging apparatus emitting a blue-purple laser at a wavelength of 405 nm. The exposure pattern used was a pattern having lines of 20, 30, 40, 50, 60, 70, 80, 90 and 100 μm in width in the space area. The irradiation intensity used was the irradiation intensity obtained by evaluation of the optimal irradiation intensity below. After the exposure, a pattern is formed by development with an aqueous sodium carbonate solution, irradiated with UV by a high-pressure mercury lamp at an intensity of 1,000 mJ/cm², and hardened at 150° C. for 60 minutes, to obtain a hardened coated film. The cross section of a designed 100-μm line region of the hardened coated film was observed.

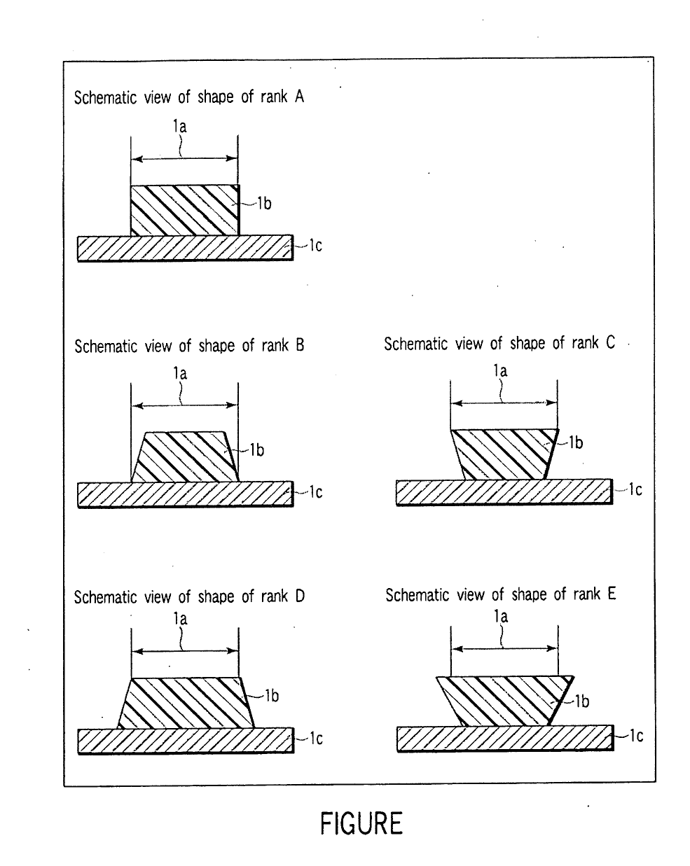

The shapes were grouped into five ranks of A to E respectively corresponding to the schematic views shown in FIGURE. FIGURE shows schematic views when the following phenomenon occurs. In FIG. 1a represents a designed line width; 1b represents a resin composition after exposure and development; and 1c represents a substrate. In particular at the rank A, the deviation in line width from the design value is not larger than 5 μm at the top or bottom of the line. The results are summarized in Table 2.

Rank A: ideal state with designed width
Rank B: corrosion of surface layer for example by insufficient development resistance
Rank C: undercut state
Rank D: line thickening for example by halation
Rank E: line thickening of surface layer and undercut

### <Optimal Irradiation Intensity>

Each of the photocurable and thermosetting resin compositions obtained in Examples 1 to 12 and Comparative Examples 1 to 3 was applied over the entire surface of each evaluation substrate by screen printing. After drying in a hot air-circulating dryer, a negative pattern with lines of 50 to 130 μm in width was placed on the coated film, and the coated film was exposed to light in a direct imaging apparatus emitting a blue purple laser at a wavelength of 405 nm. Then, the film was developed, as immersed in a 1.0 mass % aqueous sodium carbonate solution for 60 seconds. The lowest irradiation intensity giving a resolution of 60 μm was designated as the optimal irradiation intensity.

### <Absorbance>

The absorbance was determined by using an ultraviolet-visible spectrophotometer (Ubest-V-570DS, manufactured by JASCO Corp.) and an integrating-sphere photometer (ISN-470, manufactured by JASCO Corp.). Each of the photocurable and thermosetting resin compositions obtained in Examples 1 to 12 and Comparative Examples 1 to 3 was applied on a glass plate with an applicator and dried in a hot air-circulating drying oven at 80° C. for 30 minutes, to prepare a dry coated film of the photocurable and thermosetting resin composition on the glass plate. The absorbance base line was drawn in a wavelength range of 500 to 300 nm by using the same glass plate as that used for application of the photocurable and thermosetting resin composition, by using the ultraviolet-visible spectrophotometer and the integrating-sphere photometer. The absorbance of each glass plate carrying a dry coated film was determined; and the absorbance of the dry coated film was calculated from the base line, to obtain the absorbance of the desirable light at a wavelength of 405 nm. For prevention of deviation in absorbance due to the difference in coated film thickness, the operation was repeated four times while the coating thickness with applicator was changed in four orders; a graph showing the relationship between the coating thickness and the absorbance at 405 nm was obtained; and the absorbance of a dry coated film at a film thickness of 25 μm was calculated, based on the approximate expression thus obtained.

The evaluation results are summarized in Table 2.

TABLE 2

| | Exam. | | | | | | | | | | | | Comp. | | |
|---|---|---|---|---|---|---|---|---|---|---|---|---|---|---|---|
| | 1 | 2 | 3 | 4 | 5 | 6 | 7 | 8 | 9 | 10 | 11 | 12 | 1 | 2 | 3 |
| Surface | ♯ | ♯ | ♯ | ♯ | ♯ | ♯ | ♯ | ♯ | ♯ | Δ | Δ | ♯ | *¹Im- | *¹Im- | *²Exfoliation |
| curability | | | | | | | | | | | | | Possible | Possible | |
| Cross | A | A | A | A | A | A | A | A | A | A | D | E | | | |
| sectional shape | | | | | | | | | | | | | | | |
| Optimal | 20 | 30 | 150 | 120 | 80 | 30 | 40 | 80 | 70 | 30 | 60 | 30 | | | |
| irradiation | | | | | | | | | | | | | | | |
| intensity | | | | | | | | | | | | | | | |
| (mJ/cm²) | | | | | | | | | | | | | | | |
| 405 nm | 0.55 | 0.76 | 0.61 | 0.59 | 0.65 | 0.61 | 0.47 | 0.39 | 0.39 | 0.52 | 0.35 | 1.35 | 0.39 | 0.53 | 0.41 |
| absorbance | | | | | | | | | | | | | | | |
| (per 25 μm | | | | | | | | | | | | | | | |
| film thickness) | | | | | | | | | | | | | | | |
| Color of | Transparence | Blue | Blue | Blue | Blue | Blue | Blue | Blue | Blue | Blue | Blue | Blue | — | — | Yellow |
| coated film | | | | | | | | | | | | | | | |

*¹It was impossible to obtain a coated film.
*²Exfoliation was partially induced.

In addition, the results obtained by using a photomask and an exposure device (GW20 manufactured by ORC) carrying a metal halide lamp, replacing the blue purple laser used in the evaluation method shown in Table 2, are summarized in Table 3.

TABLE 3

| | Exam. | | | | | | | | | | | | Comp. | | |
|---|---|---|---|---|---|---|---|---|---|---|---|---|---|---|---|
| | 1 | 2 | 3 | 4 | 5 | 6 | 7 | 8 | 9 | 10 | 11 | 12 | 1 | 2 | 3 |
| Surface curability | ♯ | ♯ | ♯ | ♯ | ♯ | ♯ | ♯ | ♯ | ♯ | ♯ | ♯ | ♯ | ♯ | ♯ | ♯ |
| Cross sectional shape | E | E | A | A | C | E | E | E | E | E | E | E | E | E | E |
| Optimal irradiation | 15 | 20 | 150 | 100 | 50 | 20 | 20 | 20 | 15 | 20 | 30 | 20 | 300 | 400 | 100 |
| intensity (mJ/cm²) | | | | | | | | | | | | | | | |
| 405 nm absorbance | 0.55 | 0.76 | 0.61 | 0.59 | 0.65 | 0.61 | 0.47 | 0.39 | 0.39 | 0.52 | 0.35 | 1.35 | 0.39 | 0.53 | 0.41 |
| (per 25 μm film | | | | | | | | | | | | | | | |
| thickness) | | | | | | | | | | | | | | | |
| Color of coated film | Transparence | Blue | Blue | Blue | Blue | Blue | Blue | Blue | Blue | Blue | Blue | Blue | Blue | Green | Yellow |

As apparent from the results in Table 2 above, the present invention provides a photocurable and thermosetting resin composition having a high photopolymerization potential as excited by a laser beam at 400 to 410 nm, giving sufficiently high in-depth curability, being superior in surface curability and thermostability, and being particularly suitable, as a solder resist application, for direct imaging by a laser beam of 400 to 410 nm, the cured product thereof, and a printed wiring board patterned by using the same.

In addition, as apparent from the results shown in Table 3, the present invention provides a photocurable and thermosetting resin composition having a high photopolymerization potential as excited by conventional beam sources such as a metal halide lamp, having sufficient in-depth curability, and being superior in surface curability and thermostability, which is favorably used especially in the solder resist application, and a printed wiring board carrying a pattern formed by using the same.

What is claimed is:

1. A photocurable and thermosetting resin composition developable with a dilute alkali solution containing:
(A) an ethylenic unsaturated group-containing and carboxylic acid-containing resin, (B) a coumarin skeleton-containing sensitizer having a maximum absorption wavelength of 360 to 410 nm, as represented by the following Formula (I): 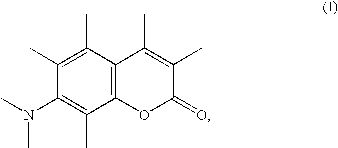
(C) a photopolymerization initiator, (D) a compound having two or more ethylenic unsaturated groups in the molecule, (E) a filler, and (F) a thermosetting component.

2. The photocurable and thermosetting resin composition according to claim 1, wherein the coumarin skeleton-containing sensitizer (B) is a compound represented by the following Formula (II):

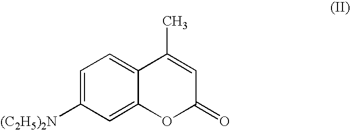

3. The photocurable and thermosetting resin composition according to claim 1, wherein the photopolymerization initiator (C) contains one or more compounds selected from the group consisting of an oxime ester-based photopolymerization initiator represented by the following General Formula (III), an aminoacetophenone-based photopolymerization initiator represented by the following General Formula (IV), an acylphosphine oxide-based photopolymerization initiator represented by the following General Formula (V), and a titanocene-based photopolymerization initiator represented by the following General Formula (VI): 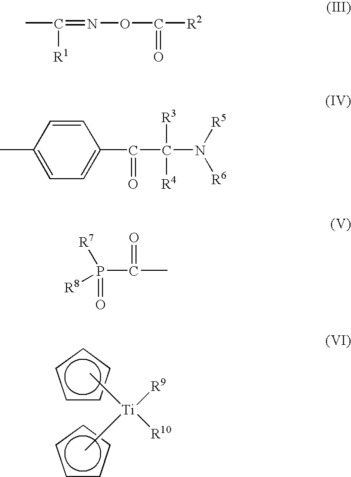
in the formulae, R¹ represents a hydrogen atom, an alkyl group having 1 to 7 carbon atoms, or a phenyl group; R² represents an alkyl group having 1 to 7 carbon atoms or a phenyl group; R³ and R⁴ each represent an alkyl having 1 to 12 carbon atoms or arylalkyl group; R⁵ and R⁶ each represent a hydrogen atom or an alkyl group having 1 to 6 carbon atoms, or may be bound to each other to form a cyclic alkyl group; R⁷ and R⁸ each represent a linear or branched alkyl group having 1 to 6 carbon atoms, a cyclohexyl group, a cyclopentyl group, an aryl group, a halogen atom, an aryl group substituted with an alkyl or alkoxy group, or a carbonyl group having 1 to 20 carbon atoms, with the proviso that R⁷ and R⁸ are not carbonyl groups having 1 to 20 carbon atoms simultaneously; and R⁹ and R¹⁰ each represent a halogen atom, an aryl group, a halogenated aryl group, or a halogenated aryl group having a heterocyclic ring.

4. The photocurable and thermosetting resin composition according to claim 3, wherein the oxime ester-based photopolymerization initiator represented by the General Formula (III) is a compound represented by the following Formula (VII):

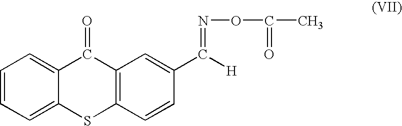

5. The photocurable and thermosetting resin composition according to claim 1, further containing (G) dialkylaminobenzophenone and/or (H) thioxanthone compound.

6. The photocurable and thermosetting resin composition according to claim 1, wherein a dry coated film obtained by applying the composition diluted with an organic solvent and then drying has an absorbance of 0.3 to 1.5 per 25 μm of the film thickness at 405 nm.

7. A photocurable and thermosetting dry film obtained by applying the photocurable and thermosetting resin composition according to claim 1 onto a carrier film and drying the resin composition.

8. A cured product obtained by photocuring the photocurable and thermosetting resin composition according to claim 1 or the dry film according to claim 7 on a copper substrate.

9. A cured product obtained by photocuring the photocurable and thermosetting resin composition according to claim 1 or the dry film according to claim 7 by irradiation of a laser beam at a wavelength of 400 to 410 nm.

10. A printed wiring board having an insulation layer which is obtained by photocuring the photocurable and thermosetting resin composition according to claim 1 or the dry film according to claim 7 by irradiation of a laser beam at a wavelength of 400 to 410 nm and hardening the film thermally.
